(19) United States
(12) Patent Application Publication
(10) Pub. No.: US 2013/0009840 A1
(43) Pub. Date: Jan. 10, 2013

(54) WHIP DUAL-BAND ANTENNA

(75) Inventors: Peng Liu, Shenzhen (CN); Gee Siong Kok, Shenzhen (CN)

(73) Assignee: Hytera Communications Corp., Ltd., Shenzhen, Guangdong (CN)

(21) Appl. No.: 13/636,641

(22) PCT Filed: Mar. 24, 2010
(86) PCT No.: PCT/CN2010/071272

§ 371 Date: Sep. 21, 2012

(51) Int. Cl. H01Q 5/01; H01Q 9/06

(52) U.S. Cl. 343/843; 343/895

(57) ABSTRACT

A whip dual-band antenna is disclosed in the present invention, and includes a radiator which is connected with a radio via a feed point of the radio, wherein the radiator includes a linear first radiator for generating a first resonance, a helical second radiator is set on the top of the first radiator in an inverse series manner, and the second radiator is used for generating a second resonance whose frequency is higher than the resonance frequency of the first radiator. In the present invention, by adding additionally a second radiator with a higher resonance frequency on the top of a first radiator dexterously, the length of the model of the second resonance frequency is increased, and the effect of the change of the UltraHigh Frequency (UHF) band is decreased. The antenna performance is better concentrated on the upper hemisphere when the dual-band antenna is operating in the Global Positioning System (GPS) frequency band, so as to implement a better GPS gain performance without affecting the effect in the UHF band.

### FIELD OF THE INVENTION

The present invention relates to an antenna, and in particular to a whip dual-band antenna.

### BACKGROUND OF THE INVENTION

In today's information society, people usually want to receive useful information conveniently, and thus various portable wireless communication devices are widely used in people's daily life. In a wireless communication device, an antenna used for transmitting and receiving radio waves to communicate radio signals is undoubtedly one of the very important elements. For most handheld terminal devices, the antenna needs to be light and small. In addition, the antenna is required to be operable for dual-band, and the frequency band of the antenna is required to be wider.

At present, a handheld terminal device is usually provided with several frequency ranges, such as frequency ranges required by Global System for Mobile Communications (GSM) and Digital Cellular System (DCS) of mobile telephones (GSM+DCS) as well as ultra high frequency (UHF) and a frequency of Global Positioning System (GPS) of interphone, to implement several functions or auxiliary functions. Therefore, the antennas of the handheld terminal device are a dual-band antenna or multi-band antenna.

In the prior art, a dual-band antenna with a double branch structure is usually used in mobile telephone antenna design. The design idea is to lead out two radiation branch with different lengths from a feed point to generate resonances of different frequencies respectively.

In the prior art, a dual-band antenna with a partial resonance structure is also usually used to design a higher frequency range with a different structure parameter. As shown in FIG. 1, a kind of frequency is generated by the whole helix, while the high frequency resonance is generated by the helix part with the different parameter. For example, in the antennas of an early mobile telephone, the DCS frequency range is usually placed at the bottom of the coil to process.

An exposed dual-band antenna in existing art is usually implemented with the partial resonance structure with a helical structure, i.e., a double pitch helical antenna. In this structure, the high frequency resonance part is placed at the bottom of the coil, which is combined with the other part to constitute a low frequency resonance. However, an exposed dual-band antenna of an interphone is operated in an operating mode of UHF+GPS frequency range. As shown in FIG. 2, the GPS resonance part is placed at the bottom of the helix to form the resonance in the prior art, by which the performance of the antenna is mostly concentrated on the lower hemisphere, and the performance on the upper hemisphere required by GPS (a part directing to the sky) is poor and is not suitable for a specialized GPS performance and a function positioning of the professional terminal device. Moreover, in this design, the bandwidth of the UHF frequency range is narrow due to the influence of the GPS frequency range.

In order to solve problems of the performance of GPS frequency range of antenna, in the existing UHF+GPS exposed dual-band antenna, the GPS resonance part is placed at the top of the antenna coil, as shown in FIG. 3, so as to obtain a GPS receiving performance concentrated upwardly. The GPS performance will reach a relatively poor state when UHF frequency is about certain integral multiple of GPS frequency, which is determined by a special frequency range relationship and is unavoidable. For this antenna, UHF is operated in the first resonance mode, i.e., the total length of the coil is about half of the resonance wavelength, and the length of the top GPS is also about half of the wavelength, and therefore the GPS performance is greatly affected by the UHF frequency range.

### SUMMARY OF THE INVENTION

Technical problems to be solved by the present invention are that: for the above disadvantages in the prior art, a whip dual-band antenna is provided, so that the antenna performance is better concentrated on the upper hemisphere when the dual-band antenna is operated in the GPS frequency range, and GPS performance is achieved better without affecting the UHF performance.

Technical solutions for solving the technical problems in the present invention are: constructing a whip dual-band antenna including a radiator connected to a radio via a feed point of the radio, wherein the radiator includes a first radiator with a linear shape for generating a first resonance; and a second radiator with a helical structure for generating a second resonance with a higher resonance frequency than the first radiator, which is provided at the top of the first radiator in a series opposing.

For the whip dual-band antenna of the present invention, a total length of the second radiator is ¼-½ of a wavelength of the second resonance.

For the whip dual-band antenna of the present invention, the current of the second radiator is in the same direction as a current at the top of the first radiator, and an operating length of the second radiator is a length where two half-wave dipoles are superposed.

For the whip dual-band antenna of the present invention, a total length of the first radiator is ½ of the wavelength of the first resonance.

For the whip dual-band antenna of the present invention, the first radiator uses a whip antenna.

For the whip dual-band antenna of the present invention, the second radiator uses a GPS resonance coil.

The whip dual-band antenna of the present invention has the following advantages: the second radiator with a higher resonance frequency is provided on the top of the first radiator, the length of the second resonance frequency model is increased, and thus influence of the UHF frequency range variation is decreased, the antenna performance of the dual-band antenna operated in the GPS frequency range is better concentrated on the upper hemisphere, and a better GPS gain performance is achieved without affecting the UHF effect.

### BRIEF DESCRIPTION OF THE DRAWINGS

The present invention will be further explained below in conjunction with drawings and embodiments. In drawings,

FIG. 1 is a schematic structure diagram of a dual-band antenna with a partial resonance structure according to the prior art;

FIG. 2 is a schematic structure diagram of an exposed dual-band antenna with a GPS resonance part provided at a bottom of a helix according to the prior art;

FIG. 3 is a schematic structure diagram of an exposed dual-band antenna with a GPS resonance part provided at a top of a helix according to the prior art;

FIG. 4 is a gain pattern of a GPS frequency range of a dual pitch helical antenna according to the prior art;

FIG. 5 is a schematic structure diagram of a whip dual-band antenna according to the present invention;

FIG. 6 is frequency band specification of a simulation result of a UHF frequency range of a whip dual-band antenna according to the present invention;

FIG. 7 is UHF radiation pattern specification of a simulation result of a UHF frequency range of a whip dual-band antenna according to the present invention;

FIG. 8 is frequency band parameters of a simulation result of a UHF frequency range of a whip dual-band antenna according to the present invention;

FIG. 9 is radiation pattern parameters of a simulation result of a UHF frequency range of a whip dual-band antenna according to the present invention;

FIG. 10 is frequency band specification of a fine tuning whip dual-band antenna sample according to the present invention;

FIG. 11 is a gain radiation pattern of a whip antenna according to the present invention; and

FIG. 12 is another gain radiation pattern of a whip antenna according to the present invention.

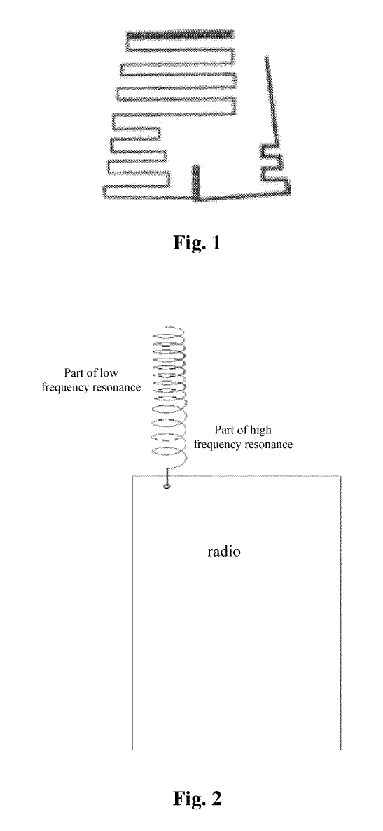

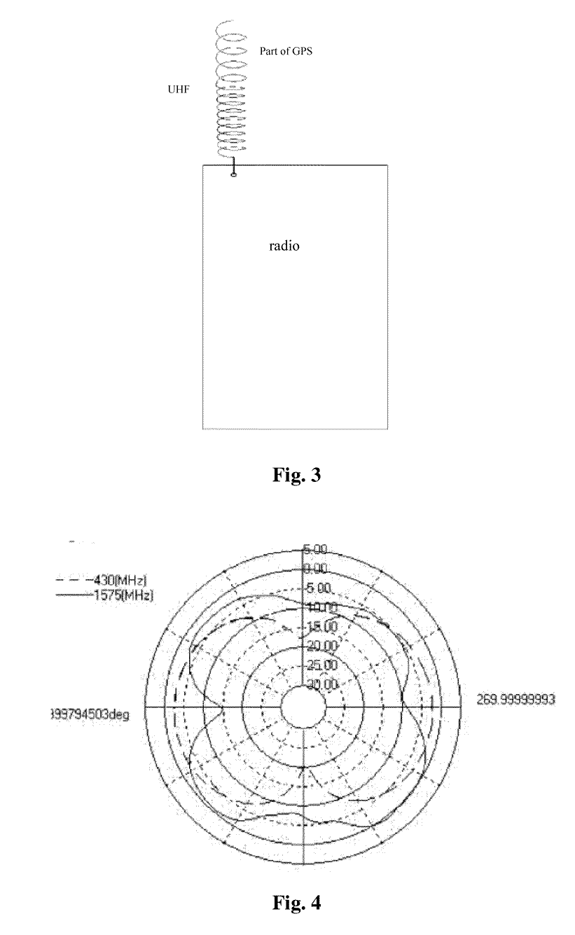

### DETAILED DESCRIPTION OF THE INVENTION

Preferable embodiments of the present invention will be described in detail below in conjunction with the drawings.

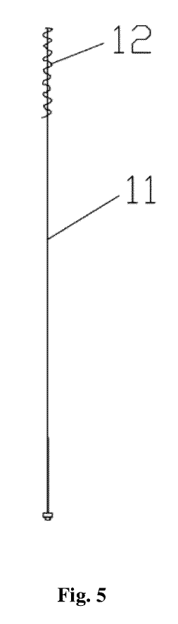

A structure of a whip dual-band antenna according to a preferable embodiment of the present invention is shown in FIG. 5, which includes a radiator connected to a radio via a feed point of the radio. The radiator includes two parts, the first part is a first radiator 11 with a linear shape for generating a first resonance, such as a whip antenna; and the second part is a second radiator 12 with a helical structure for generating a second resonance with a higher resonance frequency than the first radiator 11, such as a GPS resonance coil, where the second radiator 12 is provided on the top of the first radiator 11 in a series opposing. The first radiator 11 mainly generates the first resonance in the UHF frequency range (300-800 MHz). The length of the second radiator 12 is a resonance length of the whip dual-band antenna operated in the GPS operating frequency range. The coil pitch may be adjusted by the coupling effect of the first radiator 11 and the second radiator 12, so as to tune the GPS resonance of different UHF frequency ranges.

By providing the second radiator 12 on the top of the first radiator 11 in a series opposing, the current of the second radiator 12 is in the same direction as the upper current of the first radiator 11, such that the actual operating length of the second radiator 12 is equivalent to a length where two half-wave dipoles are superposed, and actually the length of the second resonance frequency model of the second radiator 12 is increased. Therefore, the influence of the variation of UHF frequency range on the second radiator is decreased, and the antenna has a good directivity on the upper hemisphere, which is better than the directivity in the case that one half-wave dipole is operated.

Preferably, the total length of the second radiator 12 is ¼-½ of the resonance wavelength of the second radiator, and the total length of the first radiator 11 is ½ of the wavelength of the first resonance, and thus the UHF frequency range may not affect the GPS frequency range, such that the whip dual-band antenna has a better directivity, the dual-band tune is achieved in the whole frequency range (300-800 MHz) of UHF, and the whip dual-band antenna can operate in more frequency ranges.

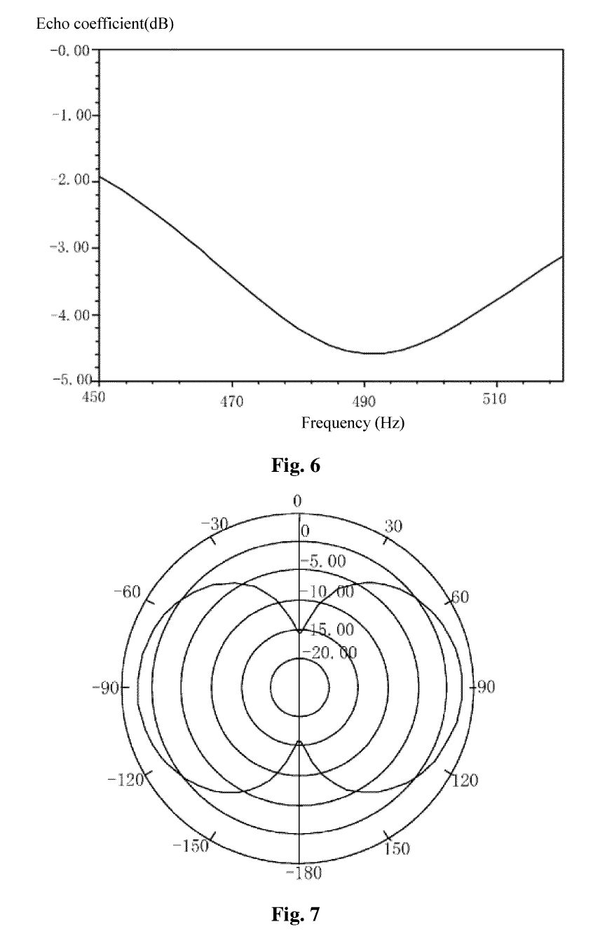

Frequency band specification of a simulation result of UHF of a whip antenna according to the whip dual-band antenna of the present invention are shown in FIG. 6, UHF radiation pattern of a simulation result of UHF of the whip antenna are shown in FIG. 7. For clarify, the simulation software is set to merely show the structure of the antenna and hide the part of the radio. The simulation result of FIG. 6 and FIG. 7 are idea values in the case that a sheath of an antenna and a radio shield are not used and the PCB loss is took no account.

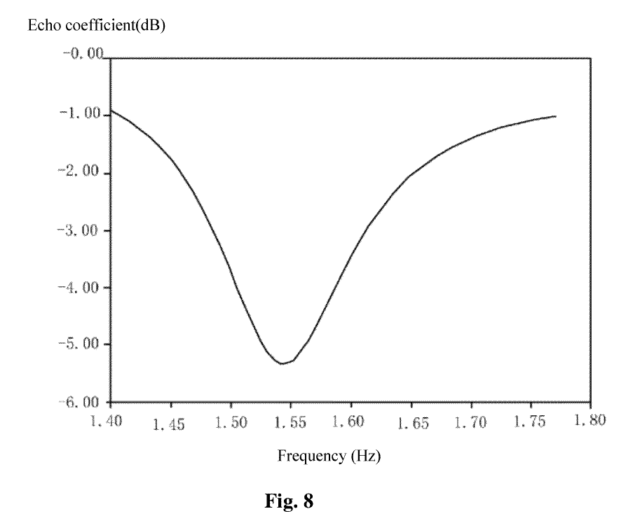

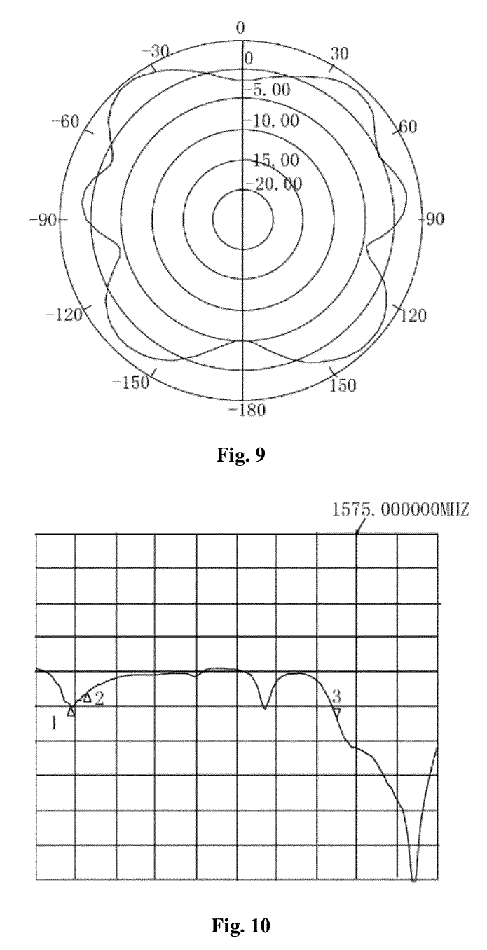

In the present embodiment, taking UHF (470-520 MHz) +GPS as a simulation model, frequency band parameters of the simulation data of the UHF frequency range of the whip dual-band antenna are shown in FIG. 8, radiation pattern parameters of the simulation result of the UHF frequency range are shown in FIG. 9. The simulation gain data in FIG. 8 and FIG. 9 are idea values in the case that a sheath of an antenna and a radio shield are not used and the PCB loss is took no account.

As can be seen from FIG. 8 and FIG. 9, in the case that the second radiator (a GPS resonance coil) is provided on the top of the first radiator (a whip antenna), the gain radiation pattern of GPS is better. Compared with the GPS frequency range radiation pattern of the double pitch helical antenna shown in FIG. 4, there is more energy toward sky, and there is no concave in the central or the gain which is weakened according to the direction, as shown in FIG. 4. The antenna performance of the dual-band antenna operated in the GPS frequency range is better concentrated on the upper hemisphere, which is better than the antenna performance of the double pitch helical antenna. Moreover, it can be seen from the radiation pattern of the GPS frequency range and the simulation result of the UHF frequency range in FIG. 6 and FIG. 7 that the performance of the UHF frequency range is almost unaffected and dual-band turn can be achieved well in the whole frequency range (300-800 MHz) of UHF.

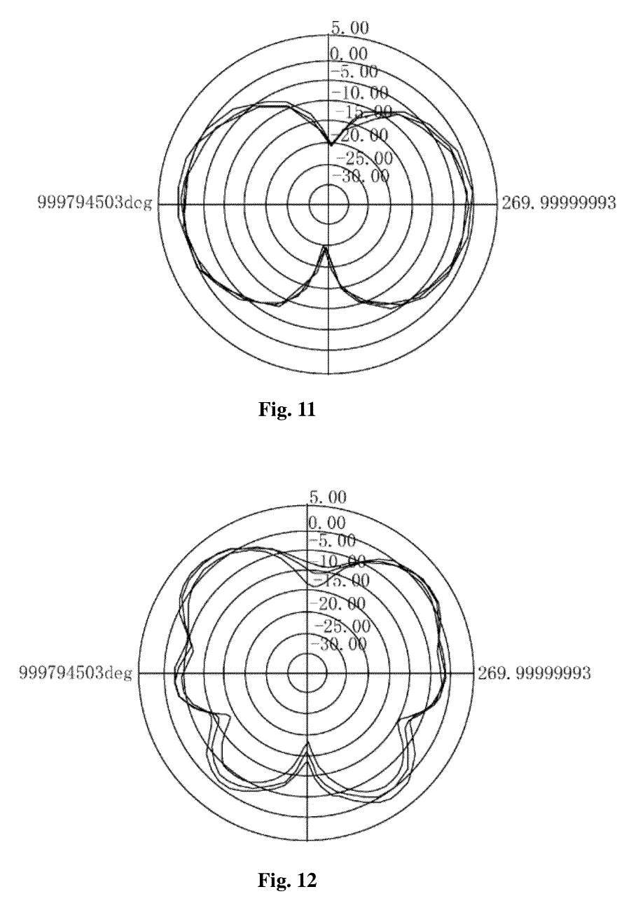

A whip dual-band antenna sample according to the above design is tested in a chamber, and the range of the simulation frequency thereof is from 300 MHZ to 2000 MHZ, so as to obtain the frequency band parameter shown in FIG. 10 and the gain direction shown in FIG. 11 and FIG. 12. Reference numbers 1, 2, 3 in FIG. 10 present the first resonance, the second resonance and the third resonance respectively. As can be seen, the third resonance of the whip dual-band antenna is not at 1575 MHz but higher than 1575 MHz, which can be adjusted by a variable pitch GPS resonance coil and will not affect the antenna GPS gain radiation pattern.

According to the whip dual-band antenna of the present invention, the length of the second resonance frequency model is actually increased by providing the second radiator with a higher resonance frequency on the top of the first radiator, so as to decrease the influence of the second radiator on the UHF frequency range variation. Therefore, the antenna performance of the dual-band antenna operated in the GPS frequency range is better concentrated on the upper hemisphere, and a better GPS gain performance is achieved without affecting UHF frequency range effect.

The above is merely preferable embodiments of the present invention, and does not intent to limit the present invention, and any amendments, equivalent substitutions or improvements within spirit and principle of the present invention are all included in the protection scope of the present invention.

What is claimed is:

1. A whip dual-band antenna, comprising a radiator connected to a radio via a feed point of the radio, wherein the radiator comprises a first radiator with a linear shape for generating a first resonance; and a second radiator with a helical structure for generating a second resonance with a higher resonance frequency than the first radiator, which is provided at the top of the first radiator in a series opposing.

2. The whip dual-band antenna according to claim 1, wherein a total length of the second radiator is ¼-½ of a wavelength of the second resonance.

3. The whip dual-band antenna according to claim 1, wherein the current of the second radiator is in the same direction as a current at the top of the first radiator, and an operating model of the second radiator is operated in the mode that two half-wave dipoles are superposed.

4. The whip dual-band antenna according to claim 1, wherein a length of the first radiator is ½ of a wavelength of the first resonance.

5. The whip dual-band antenna according to claim 1, wherein the first radiator uses a whip antenna.

6. The whip dual-band antenna according to claim 1, wherein the second radiator uses a GPS resonance coil.
